(19) United States
(12) Patent Application Publication
(10) Pub. No.: US 2024/0036229 A1
(43) Pub. Date: Feb. 1, 2024

(54) AUTONOMOUS VEHICLE SYSTEMS AND METHODS FOR GRAVITY GRADIOMETRY

(71) Applicant: Oqab Dietrich Induction Inc., Kitchener (CA)

(72) Inventors: Haroon B. Oqab, Kitchener (CA); George B. Dietrich, Kitchener (CA); Ilia Tomski, Kitchener (CA)

(21) Appl. No.: 18/038,657

(22) PCT Filed: Nov. 24, 2021
(86) PCT No.: PCT/CA2021/051684

§ 371 Date: May 24, 2023

Related U.S. Application Data
(60) Provisional application No. 63/117,625, filed on Nov. 24, 2020.

(51) Int. Cl. G01V 7/16; B64U 10/00

(52) U.S. Cl. CPC G01V 7/16; B64U 10/00; B64U 2101/35

(57) ABSTRACT

A system comprising one or more autonomous vehicles equipped with sensors to perform continuous multi-domain gravity gradiometry measurements to better understand density variation of an object, surface and/or subsurface. The autonomous vehicles may be equipped with modular customizable sensor packages having a plurality of gravity gradiometry sensors with differing sensitivities. Each sensor may be tethered to the autonomous vehicle by a tether which can be lengthened or shortened to vary the distance between the sensor and the ground. The autonomous vehicles may include an onboard data processing and visualization system configured for generating a survey model of a scanned area and/or volume based on the data received sensors on one or more autonomous vehicles. The data system may be configured to implement data-driven processes in a feedback loop to optimize positioning of the autonomous vehicle system to record measurements with less noise to refine the survey model.

### TECHNICAL FIELD

The embodiments disclosed herein relate to gravity gradiometry, and in particular to, autonomous vehicle systems and methods for gravity gradiometry.

### INTRODUCTION

Gravity gradiometry is routinely considered as a component for geophysics and resource exploration activities, as well as being deployed for global information gathering. Airborne subsurface imaging is used to map changes in geology and image important subsurface structures to aid the exploration and search for natural resources over both land and water. The data is acquired by flying grid patterns over the surface of the Earth. Current airborne gravity gradiometers generally use crewed systems employing aerial vehicles such as fixed wing airplanes or helicopters to perform surveys.

These existing systems have several drawbacks such as: limited subsurface depth of exploration given the aerial position of the gradiometer; vulnerability to weather and terrain limiting flight paths; expensive flight components and data collection line by line is costly and time-consuming; and potential risk of loss of human life from aircraft accidents.

A further difficulty is limited applications in respect to what can be imaged/discovered by existing systems due to high inherent noise in gradiometry data acquired from high sensitivity gravity sensors. The noise is generated by numerous sources, for example, drag caused by movement of the vehicle, environmental factors including turbulence, weather, temperature, etc., and vibrations emanating from the vehicle's moving parts.

Accordingly, there is a need for systems and methods for gravity gradiometry to generate accurate and precise gradiometry data that addresses the above limitations of existing systems.

### SUMMARY

According to some embodiments, there is a system comprising one or more autonomous vehicle systems equipped with sensors to perform multi-domain gravity gradiometry measurements to better understand density variation of an object, surface and/or subsurface. A fleet of such autonomous vehicles equipped with customizable sensor packages are designed for: resource identification, monitoring, and utilization (exploration, mining, extraction, processing, manufacturing, and stewardship of natural resources on Earth and in Space).

The system includes a first autonomous vehicle having a first sensor package, to scan an area by movement of the first autonomous vehicle across the area in a first predetermined path. The system includes at least a second autonomous vehicle having a second sensor package, to scan the area by movement of the second autonomous vehicle across the area in a second predetermined path. A data processing system receives the sensor data from the first sensor package and the second sensor package to generate a survey model of the area.

The first and the second autonomous vehicles may be configured to hover in a lateral two-dimensional formation at an altitude above the ground to reduce noise in gravity gradiometry measurements.

According to an embodiment, there is a motion isolated autonomous vehicle platform for gravity gradiometry. The motion isolation platform comprises at least three autonomous vehicles tethered to a gravity gradiometry sensor suspended below, and substantially equidistant to, each of the autonomous vehicles. Each autonomous vehicle is tethered to the sensor by a tether that can be lengthened or shortened to raise or lower the sensor with respect to the autonomous vehicles. The three-dimensional movement of the autonomous vehicles and the lengthening/shortening of the tethers are coordinated to change a position or an altitude of the tethered sensor and minimize vibration felt by the sensor.

The present autonomous vehicle system provides new innovations and capabilities for systems and methods of gravity gradiometry, for example: introducing autonomy to streamline operations and logistics; utilization of a fleet of autonomous vehicle systems; high scanning capability; hybrid operations; data fusion; data collection and processing; machine learning/artificial intelligence; visualization in a mixed reality environment; repeatable measurements; validation processes; and/or the ability to measure and integrate gravity gradient data into an exploration program leading to more discoveries and/or reducing the risks of false positives.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a diagram of an autonomous vehicle system for gravity gradiometry, according to an embodiment;

FIG. 2A is a diagram of a rapid resolution surveying system of autonomous vehicles for rapid data collection, according to an embodiment;

FIG. 2B is a diagram of the motion isolation platform shown in FIG. 2A, according to an embodiment;

FIG. 3 is a diagram of drone formation flight paths for gravity gradiometry data collection and validation, according to several embodiments;

FIG. 4 is diagrams of modular, scalable fleets of drones for distributed measurement systems, according to several embodiments;

FIG. 5 is diagrams of autonomous and semi-autonomous drones for airborne gravity gradiometry, according to several embodiments;

FIG. 6 is a diagram of a towed control system, according to an embodiment; and

FIG. 7 is a diagram of operating environments for gravity gradiometry autonomous vehicle systems.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud based program or system, laptop, personal data assistance, cellular telephone, smartphone, or tablet device.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

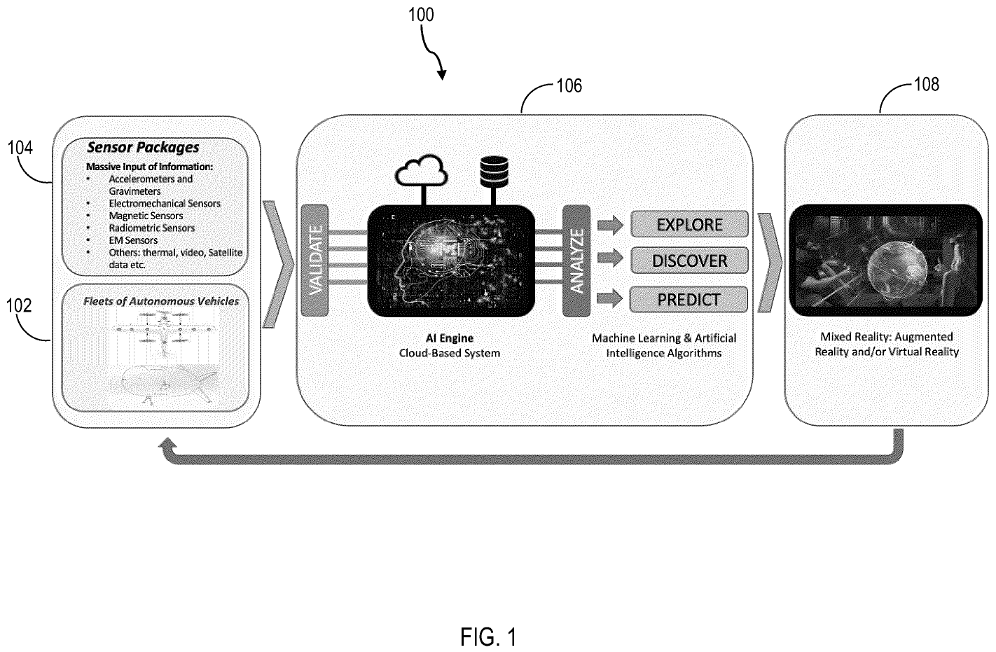

FIG. 1 shows a system 100 comprising one or more uncrewed (autonomous) vehicle systems 102 equipped with sensors 104 to perform gravity gradiometry measurements to better understand density variation of an object, a surface and/or a subsurface area. The system 100 may be implemented to provide rapid data collection with significantly lower noise and higher resolution, faster and uniform coverage with ease of access than surface gravimetry. These significant advantages to performing exploration surveys from the air result in lower operational costs. The system 100 may further provide environmentally-friendly, non-intrusive technology (compared to existing manned systems) with rapid scanning and highly sensitive measurement capabilities of mapping Earth's subsurface by density for identifying new sources, monitoring, and sustainable development of resources to meet demands of a growing global population.

The system 100 maps the subsurface geology by measuring density variations from a fleet of unmanned aircraft systems 102 equipped with customizable sensor packages 104, linked to a machine learning/artificial intelligence data processing and visualization system 106, and visualized in a mixed reality environment 108. A fleet of autonomous vehicles 102 equipped with customizable sensor packages 104 may be configured for: resource identification, monitoring, and utilization (exploration, mining, extraction, processing, manufacturing, and stewardship of natural resources).

Generally, gravity gradiometry sensors using accelerometers, or the like, are passive sensors that measure the rate of change of the gravity vector in three perpendicular directions giving rise to a gravity gradient tensor. The sensor packages 104 may include one or more gravimeters, electromechanical sensors, magnetic sensors, radiometric sensors and/or electromagnetic sensors to obtain a plurality of measurements. The sensor packages 104 may further include RADAR, LIDAR and cameras and/or other measurement instruments for capturing a view of the environment to direct the path of the autonomous vehicles 102.

Flight operations of a fleet (or swarm) of autonomous vehicles 102 may be coordinated to maximize data collection. For example, sensors 104 may be distributed across a population of autonomous vehicles 102 and predetermined flight paths are adapted to optimize for performance and for resource identification, tracking and in-situ monitoring, or the like. Different classes of autonomous vehicles 102 may be equipped with different sensor packages 104.

Autonomous vehicles 102 include, but are not limited to: cars, rovers, drones, multi-copters, fixed wing aircraft systems, airships, hybrid vehicles, trains, ships, mobile platforms, autonomous underwater vehicles, satellites, spacecraft, or the like. Aerial drones and airships have hovering capabilities to perform low to high altitude semi-static measurements. Repeat measurements can be performed to measure gravity and gravity gradients, as well as to validate results.

Data and information collected from autonomous vehicle systems 102 may be processed onboard using software, machine learning (ML) and artificial intelligence (AI) of a data processing and visualization system 106. According to other embodiments, the data processing and visualization system 106 may be cloud-based and connected to the autonomous vehicle systems 102 over a network via satellite uplink/downlink.

The data system 106 is a computerized system and includes a computer processor operably coupled to a memory. The memory may be any volatile or non-volatile memory or data storage components including random access memory (RAM), read-only memory (ROM), hard disk drives, solid state drives, flash memory, memory cards accessed via a memory card reader, optical discs accessed via an optical disc drive, or a combination of any two or more of these memory components. The memory stores a plurality of instructions that are executable by the processor. In this respect, the term “executable” means a program file that is in a form that can ultimately be run by the processor. Examples of executable programs may be, for example, a compiled program that can be translated into machine code in a format that can be loaded into a random access portion of the memory and run by the processor; source code that may be expressed in proper format such as object code that is capable of being loaded into a random access portion of the memory and executed by the processor; source code that may be interpreted by another executable program to generate instructions in a random access portion of the memory to be executed by the processor; or machine learning and artificial intelligence algorithms as described herein.

The data processing and visualization system 106 may include: fleet management, autonomy and computer vision algorithms for directing the path of a single or a fleet of autonomous vehicles 102; algorithms for processing and visualizing the data from the sensors 104; and algorithms for generating results and insights for display using a user-interface on the web, mobile devices, and/or a mixed reality environment 108, or the like. As more data is made available, processes may be improved and optimized by the data processing and visualization system 106. For example, data acquisition may be optimized by adaptively varying the sampling frequency based on high noise in past measurements. In other implementations, data acquisition could be continuous but actual processed data points may be acquired at a desired point in space to perform semi-static point measurements to systematically improve the resolution and reduce noise as described below.

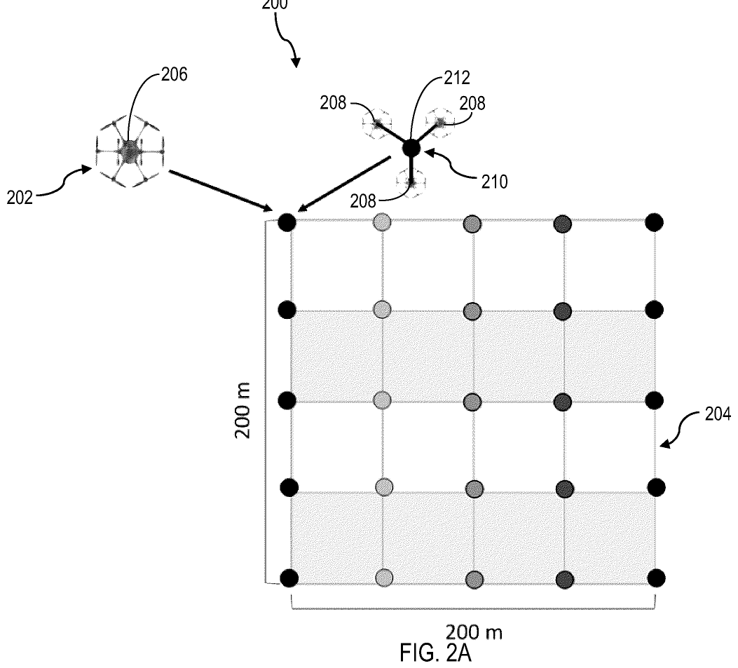

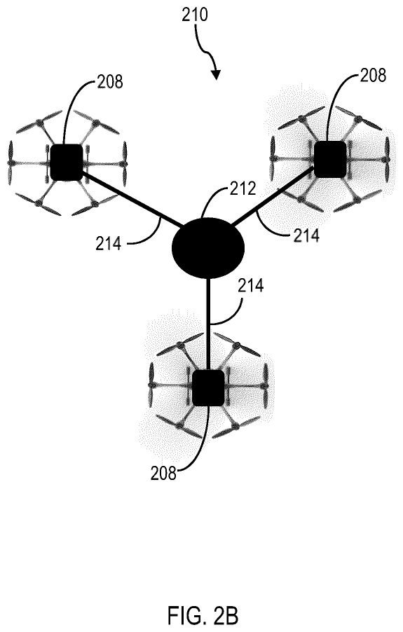

FIG. 2A shows a diagram of a rapid resolution surveying system 200 of autonomous vehicles for rapid data collection, according to an embodiment. The system 200 includes a fleet of modular drones 202 with customized sensor packages 206 (for reference a single drone 202 is identified and the circles represent 24 similar drones with various sensor packages). Sensors are distributed across the drone population and are adapted to optimize geological mapping of an area 204 (as shown, a 200×200 meter square area) by gravity gradiometry.

The system 200 may implement a “Brute Force” approach to rapidly map the area 204. The drones 202 (and sensor packages) are positioned in a matrix formation and equidistantly spaced within the area 204, having 50 m between drones. All sensors may be pre-calibrated on the ground or in-flight for gravity gradiometry measurement. Flight paths of the drones 202 are coordinated to maximize data collection in as little time as possible. The drones 202 have hovering capability to perform semi-static point measurement. The formation of drones 202 hovers over the area 204 and takes readings before moving to a next position and/or altitude; this is repeated until the entire area 204 has been covered and mapped. Each drone 204 in the formation, may include GPS, altimeter and wireless communication components to coordinate the position of the drones 204 within the formation and to follow a predetermined flight path.

According to an embodiment, for low noise measurements, the system 200 may include several drones 208 arranged to form a motion isolation platform 210 and carry a single sensor 212. Every circle in the matrix formation can be viewed as such a motion isolation platform 210 made of a subset of drones 208 (3 at minimum) serving one sensor 212. This can be done with a further increase of fleet members. Accordingly, 75 drones 208 would be required to form 25 motion isolation platforms 210 to carry 25 sensors in the formation shown in FIG. 2A.

FIG. 2B shows the motion isolation platform 210 in FIG. 2A, according to an embodiment. The motion isolation platform 210 includes at least three drones 208 positioned equidistant to the sensor 212 for gravity gradiometry measurement. Each drone 208 is connected to the sensor 212 by a tether 214. The tether 214 may be constructed of any suitable material to support the weight of the sensor 212. Preferably, the tether 214 material is semi-rigid and spool-able. The tether 214 may be a lengthened or shortened, for example, by use of a winch or similar means on each drone 208, to lower or raise the sensor 212 with respect to the drones 208. Generally, each tether 214 is lengthened or shortened by the same distance to maintain the equidistance of the sensor 212 to each drone 208.

The three-dimensional movement of the drones 208 and the lengthen/shortening of the tethers 214 is coordinated to change a position and/or an altitude of the sensor 212 while minimizing vibration felt by the sensor 212 and thus reduce noise in gravity gradiometry measurements. The drones 208 may include GPS, altimeter and wireless communication components to coordinate their relative three-dimensional positions and the lengthening/shortening of the tethers 214.

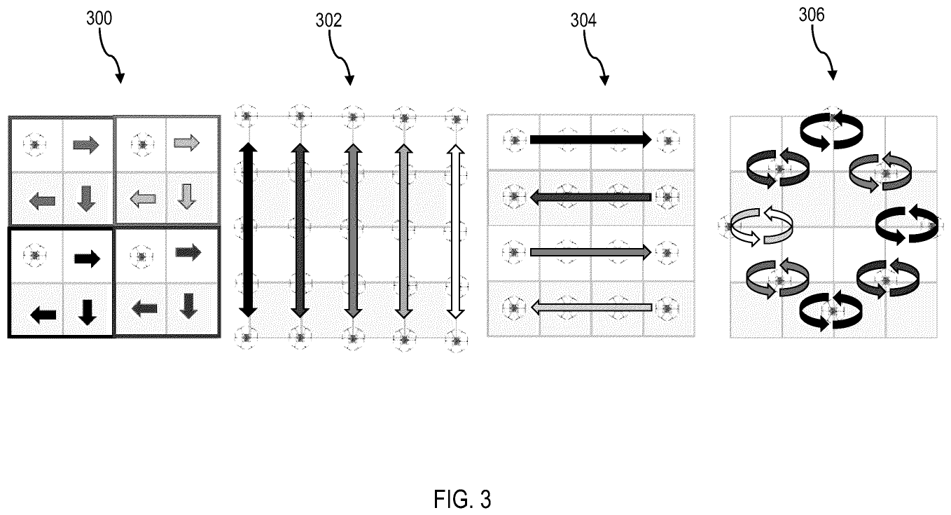

FIG. 3 shows is a diagram of drone lateral 2D formation flight paths 300, 302, 304, 306 for gravity gradiometry data collection and validation, according to several embodiments. A lateral 2D formation is one wherein each drone in the formation is at substantially the same altitude (i.e., in the same lateral plane). Noise post processing for gravity gradiometry measurements may be difficult due to high external noise input. To reduce noise, data acquisition may be continuous, but actual processed data points may be acquired at a desired point in space when the drone/sensor is hovering. Performing measurements while hovering can reduce the noise and enhance the signal.

Noise may be further reduced by controlled hovering of the entire formation during the data acquisition and cross-validating data points using various permutations of sensors following different flight paths. The initial scan speed can be slow, and compensated by using a large formation of drones to map a large area. Initially, single axis sensors carried by drones in a large lateral 2D formation and scanning along a sensitive axis of the formation over several hundred meters (e.g., ground level to 500 m above ground) may be performed. The formation may be raised/lowered to a desired point in space at various heights over the several hundred meters for data acquisition. The scan speed can be adjusted over subsequent passes based on inflight processing and feedback from AI algorithms for noise processing and flight control. In this manner, a large area may be mapped relatively quickly.

In FIG. 3, the differently shaded arrows indicate the lateral 2D flight paths of individual drones in the formation. The drones may be configured to follow predetermined formation flight paths. The drones may be configured to adjust a predetermined flight path based on input received from RADAR, LIDAR, cameras and/or other drones in the formation.

In formation flight path 300, individual drones are assigned a quadrant of a larger area to map and proceed flying around the assigned quadrant in a predetermined path until their assigned quadrant is mapped. In formation flights 302, 304 each drone flies back and forth over the entire area and interchanges position with other drones. In formation flight 306, each drone flies in a circular or concentric path and maps the area below the path. Various formation flights 300, 302, 304, 306 may be used according to the specific geography of the area to be mapped. In other implementations, a plurality of autonomous vehicles fly in formation, and the vehicles' flight components are turned on and off at desired points in space. When flight components are turned off, the vehicle falls in free fall. While the vehicle is in free fall, the sensor packages continuously record a plurality of measurements. In this manner, noise from operation of the autonomous vehicle itself is avoided in the measurements. The autonomous vehicles are turned on and off operating at different altitudes and/or point in spaces relative to each other.

Compared to existing systems, implementing a lateral 2D formation of drones to scan at various desired points in space is advantageous for repeatability of the scan area, good averaging time, unrestricted scan path and high cross-correlation for data validation. Cross validation of data points may be done by performing formation flights 300, 302, 304, 306 repeatedly over the same area and/or comparing data points from two or more individual drones within a formation flight mapping the same area.

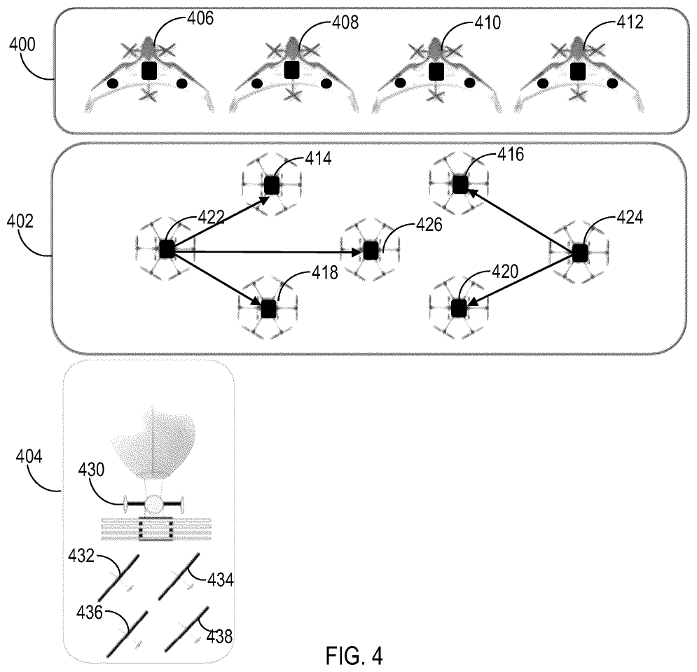

FIG. 4 shows diagrams of modular, scalable autonomous fleets of drones 400, 402, 404 for distributed measurement systems, according to several embodiments. Large distributed measurement systems can be created from smaller drone subunits. Each drone may have a modular design that can be built around customizable payloads. For example, a payload may be a sensor or sensor package placed at optimal positions for noise reduction during measurement. A payload may be on-board computing and data storage systems for postprocessing data. A payload may be batteries, solar, and wireless power transmission components, and/or the like, to increase flight endurance.

A fleet 400 may include identical drone subunits 406, 408, 401, 412, each equipped with a sensor for gravity gradiometry measurement. The fleet 400 may be scaled up to perform gravity gradiometry over a larger area up by simply adding more identical drone subunits and coordinating flight paths with the other drone subunits 406, 408, 401 and 412.

A fleet 402 may include a plurality of different drone subunits that cooperate together to perform gravity gradiometry and other functions. Some drone subunits 414, 416, 418, 420 may be equipped with sensor packages and configured to perform gravity gradiometry measurement. Other drone subunits 422, 424 may be equipped with additional batteries and configured for wireless power transmission (indicated by arrows) between drones to extend the flight time of the fleet 402. Yet another drone subunit 426 may include additional data storage and processing systems to download and process data received from the sensor drone subunits 414, 416, 418, 420.

A fleet 404 may include a hybrid command and control station utilizing a drone 430 for autonomous fleet management and security. The command and control drone 430 may be configured to direct the flight paths of sensor equipped drones 434, 434, 436 and 438 based on signal quality, noise, etc. The command and control drone 430 may further act as a “mothership” for deployment of the fleet 404 whereby drone subunits 432, 434, 436, 438 may be stored and recharged by the mothership 430 and deployed therefrom. The drone subunits 432, 434, 436 and 438 may include docking interfaces for attaching to complementary docking interface on the mothership 430.

According to an embodiment, the Fleet 404 may be configured so that the mother ship 430 deploys each drone subunit 432, 434, 436, 438 in free fall. While in free fall, the drone subunits' flight components are powered off and the sensors on the drone subunits 432, 434, 436, 438 continuously record measurements. In this manner, measurement noise from operation of the drone itself is avoided.

Each of the fleets 400, 402, 404 may be further augmented with crewed systems (i.e., conventional aircraft) for command and control, deployment or relocation of the fleet.

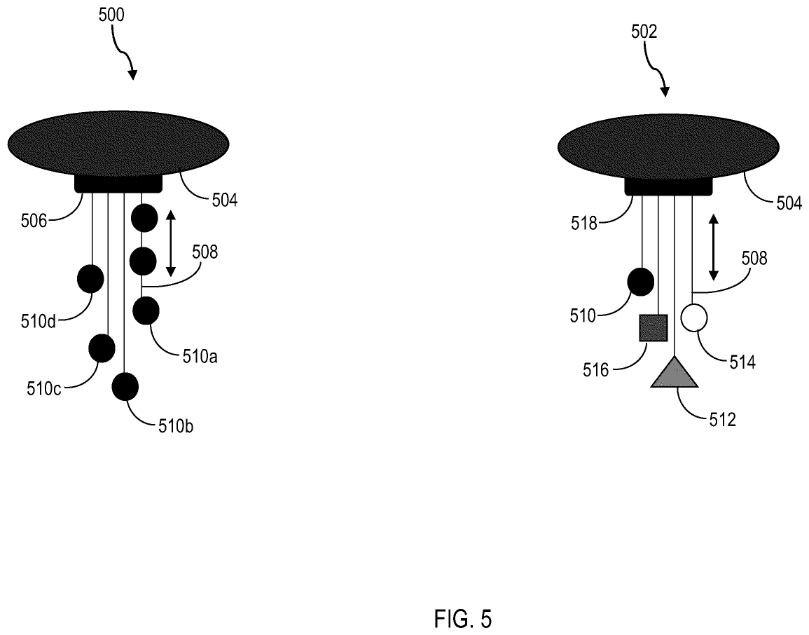

FIG. 5 shows autonomous and semi-autonomous drone systems 500, 502 for continuous data collection, according to several embodiments. The drone systems 500, 502 may be the drone 202 in FIG. 2 or any of the sensor-equipped drones, 406, 408, 410, 412, 414, 416, 418, 420 in FIG. 4. Compared to conventional crewed systems, the autonomous drone systems 500, 502 provide for continuous measurement and data collection limited only by the availability of battery power or fuel. Furthermore, the autonomous nature of the system removes human/operator error related contributions to noise in measurements.

Each drone system 500, 502 includes an aerial drone 504. The drone system 500 includes a sensor package 506 having 4 sensors 510a, 510b, 510c, 510d of the same type (e.g., electromechanical gravity gradiometry sensors). Each sensor 510 is deployable from the 504 via a tether 508. The tether 508 may be a lengthened or shortened, for example, by use of a winch or similar means on the drone 504, to lower or raise each sensor with respect to the drone 504. The tether 508 may be up to 400 feet in length.

When hovering, the drone may deploy the sensors 510a, 510b, 510c, 510d for continuous and simultaneous measurement at different altitudes above the same point on the ground. Each sensor 510a, 510b, 510c, 510d may be lowered and raised in a free fall fashion while continuously recording a plurality of measurements. Alternatively, the length of the tethers 508 may be fixed (at the same or different lengths for each sensor), and the drone 504 may change altitude to vary the height of the sensors 510a, 510b, 510c, 510d with respect to the ground. As the sensor descends, the force of gravity felt by the sensor can be factored into the measurement.

The measurements collected by each sensor 510a, 510b, 510c, 510d may be cross referenced to validate data points and/or refine the deployment height of the sensors 510a, 510b, 510c, 510d and/or the drone system 500 based on the level of noise in the measurements. Generally, measurements taken closer to the ground will have less noise and provide better resolution of the scanned area.

The drone system 502 includes a sensor package 518 having a plurality of different sensors 510, 512, 514, 516. Each sensor 510, 512, 514, 516 is deployable from the drone 504 via a tether 508 in the manner described above for drone system 500. The different sensors 510, 512, 514, 516 may be sensors for gravity gradiometry having differing sensitivities. In such case, a low-resolution scan may be initially performed using a less sensitive sensor 510, and once an area of interest is identified, a higher resolution scan using a more sensitive sensor 512 may be performed to refine or validate the initial scan.

According to other embodiments, the drone system 502 may include a sensor package 518 having different sensor types, for example a gravity gradiometer sensor 510, a RADAR 516 and a camera 514. The RADAR 516 and camera 514 may be used to map the surface topology of the ground beneath the drone 504 to direct the flight path and altitude of the drone 504 and/or adjust the lengths of the tethers to vary the height of the sensor without contacting the ground.

A further benefit of the drone systems 500, 502 is that the sensors are deployed via the tethers 508 and are thus not confined to the aircraft as in conventional gradiometry mapping systems using conventional crewed aircraft. This further reduces measurement noise caused by vibrations, mass and/or movement of the vehicle.

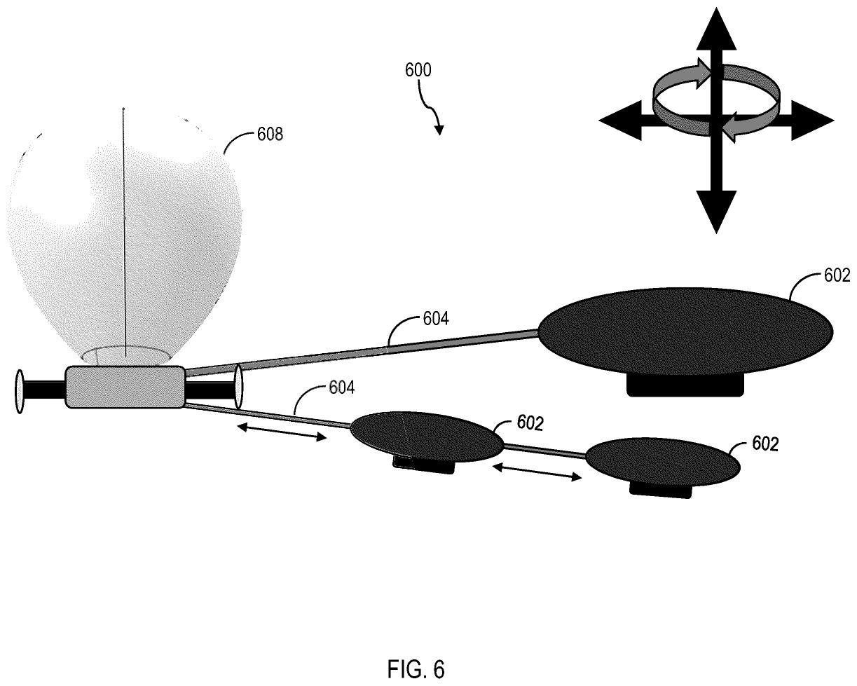

FIG. 6 shows a towed control system 600, according to an embodiment. The towed control system 600 may be used to autonomously deploy and/or reposition drones 602. The drones 602 may be the drone 202 in FIG. 2 or the drones, 406, 408, 410, 412, 414, 416, 418, 420, 422, 424, 426 in FIG. 4 or the drone systems 500, 502 in FIG. 5.

The towed control system 600 includes a drone tug 608. The drone tug 608 may be an autonomous aerial vehicle or airship. The drone tug 608 includes one or more tethers 604 for attaching to the drones 602. The tethers 604 may be lengthened or shortened using a winch, or like means, on the drone tug 608. The drones 602 may include a docking interface as a point of attachment for the tether 604. When connected via the tether 604, the drone tug 608 may tug the drone 602 to change the altitude or position of the drone 602.

Referring again to FIG. 1, the data processing and visualization system 106 combines an AI engine implementing machine learning/artificial intelligence with geophysical & geological analysis, and data fusion methodologies to provide high-definition surveying mapping. The data system 106 will ingest and analyze the data from the sensors 104 and develop/refine machine learning and statistical models for classification and/or regression type analysis in real-time.

A combination of four commonly known machine learning (ML) techniques may be implemented by the data system 106, namely: supervised learning, unsupervised learning, semi-supervised learning and reinforcement learning. Depending on the type of data that is input to the data system 106, these algorithms will be used for the purpose of classification, regression, clustering and dimensionality reduction.

Using the above machine learning models that will iteratively examine the data and learn patterns, trends, rules and relationships from it, and over time, continue to improve and grow these models as and when more data becomes available. By aggregating data from multiple feeds/sensors (e.g., gravity, seismic data, etc.) and continually analyzing all sources of information simultaneously, the maximum mutual information on desired space domain aware criteria can be obtained and enable going from data to discovery of resources, mapping of environment, etc.

In exemplary embodiment, a deployed autonomous vehicle system 100 comprises multiple autonomous aerial vehicles 102, each continuously performing gravity gradiometry measurements by a plurality of different sensors 104 at different positions and altitudes. The different sensors 104 may record complimentary data, for example, gravity gradiometry measurements of varying sensitivities at various altitudes and positions. The data from the plurality of sensors 104 is fed to the data system 106 which develops a survey model of the scanned area. In addition, the data system 106 may be configured to cross references the data from the plurality of sensors to normalize/validate the data, to refine/optimize the survey model as more data is continuously collected and processed.

The data system 106 may further optimize autonomy and computer vision algorithms for directing the path of the autonomous vehicles 102 to increase sampling density at a particular position or altitude where there is less noise in the measurements. The subsequent measurements taken at the low noise position may then be processed by the data system 106 to further optimize the survey model of the scanned area. In this manner, operation of the autonomous vehicle system 100 may be optimized through data driven processes in a feed-back loop mechanism.

Data and information output from the data system 106 can be displayed using a user-interface on the web, mobile devices, and/or a mixed reality environment 108. Augmented Reality (AR) and Virtual Reality (VR) tools provide an immersive and interactive way of displaying complex information to analyze the data and gain insights. AR technologies deliver information in a 3D space, where real-time processing areas of interest can be quickly identified to establish data-driven processes for evidence-based decision making. VR technologies can enable operators' new perspectives and visualizations to identify patterns and anomalies in the data. Symbology and data for specific applications will be developed with customer feedback, and new features and capabilities may be developed and deployed.

The data processing and visualization system 106 may be configured to provide a configurable survey model through a cloud-based platform that is accessible using a web browser interface from anywhere that has network connectivity. Through the cloud-based platform, users may upload, manipulate and curate datasets, train custom machine learning models for specialized resource identification, flight formation, prediction tasks, and interface with custom machine learning models for real time prediction processing through APIs.

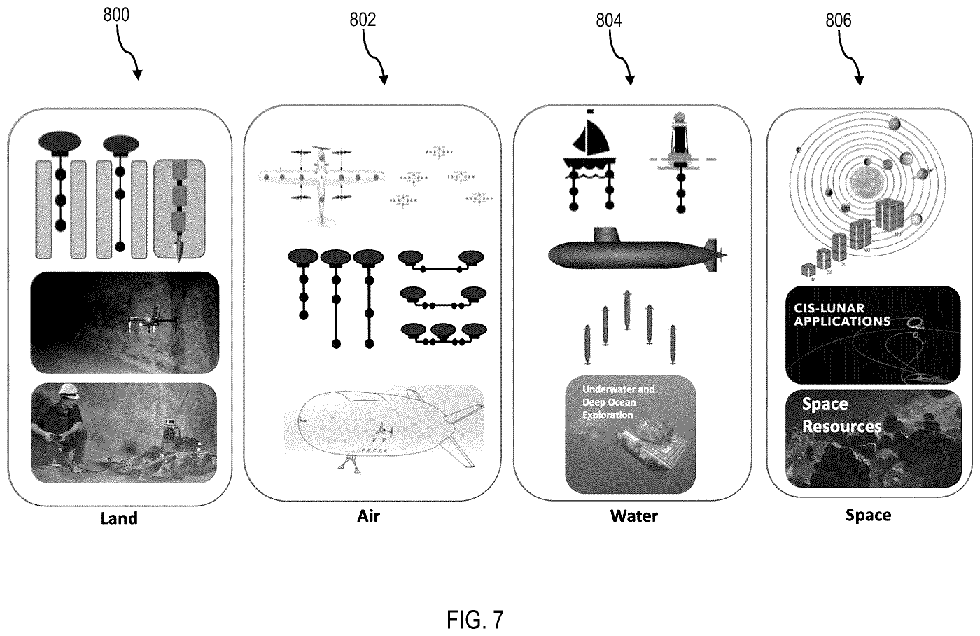

FIG. 7 is a diagram of operating environments for gravity gradiometry autonomous vehicle systems. The scalable and modular nature of the autonomous vehicle systems described herein provide for operation in a variety of remote environments including a land/subterranean environment 800, an aerial/terrestrial environment 802, an underwater environment 804 and an outer space environment 806.

In a subterranean environment 800, autonomous vehicle systems for gravity gradiometry measurement may be deployed to augment underground operations (e.g., mining, resource extraction), to rapidly map, navigate, search, and exploit complex underground environments, including human-made tunnel systems, urban underground, and natural cave networks, or the like.

As described in detail above, aerial autonomous vehicle systems may be deployed to map the subsurface geology by measuring density variations from a fleet of autonomous aerial systems equipped with customizable sensor packages, linked to a machine learning/artificial intelligence data processing pipeline, and visualized in a mixed reality environment.

Autonomous underwater vehicles can be used to map the underwater environments 804 on the ocean floor, deep ocean exploration, find resources, monitor climate change and study costal changes. For example, multi-beam echolocator data and gravity data can be combined to map and monitor the seabed and investigate properties in a range of water depths.

In an outer space environment 806, autonomous spacecraft and satellites for gravity gradiometry may be incorporated with a small satellite architecture, including cubesats or the like, to serve as a powerful cost-effective platform for space resources exploration, in orbit space services and space debris monitoring. For example, a generic satellite bus for asteroid rendezvous missions is currently under development to study asteroid size, shape, spin rate and direction, and tumbling rate. A constellation of cubesats with gravity gradiometry instruments are used for surveying and precise navigation to support asteroid mining (resource identification and utilization), cis-lunar missions, military application, intelligence gathering, security surveillance, and reconnaissance of space assets and monitoring of hostile actors.

Also, gravity gradiometry instruments can be mounted on rovers and drones to explore Lunar and Martian terrain for surface and sub-surface operations, for example, mapping lava tubes which are excellent candidates to support sustainable human lunar explorations as they provide shielding from temperature swing, space radiation, micro-meteoritic bombardment, and lunar regolith produced from spacecraft landing or departing.

While the above description provides examples of one or more apparatus, methods, or systems, it will be appreciated that other apparatus, methods, or systems may be within the scope of the claims as interpreted by one of skill in the art.

1. A system of autonomous vehicles for multi-domain gravity gradiometry, comprising:
a first autonomous vehicle having a first sensor package, wherein the first sensor package is translocated to obtain a plurality of measurements of an area or a volume of space while the first autonomous vehicle is stationary, hovering or moving in a first predetermined path;
at least a second autonomous vehicle having a second sensor package, wherein the second sensor package is translocated to obtain a plurality of measurements of the area or the volume of space while the at least second autonomous vehicle is stationary, hovering and/or moving in a second predetermined path,
wherein the first autonomous vehicle and the at least the second autonomous vehicle are motion isolated autonomous vehicle platforms; and
a data processing system for processing data received from the first sensor package and the second sensor package to generate a survey model of the area or the volume of space.

2. (canceled)

3. The system of claim 1, wherein the first predetermined path and the second predetermined path are the same.

4. The system of claim 1, wherein the first autonomous vehicle and the at least second autonomous vehicle hover in a lateral two-dimensional formation at a first altitude above the ground.

5. (canceled)

6. The system of claim 4, wherein the lateral two-dimensional formation is moved to an altitude higher or lower than the first altitude.

7. The system of claim 1, wherein the first autonomous vehicle is one of: a fixed wing vehicle, a rotary wing vehicle, a hybrid fixed-rotary wing vehicle, an airship, a train, a ship, a mobile platform, an underwater vehicle, a satellite and a spacecraft.

8. The system of claim 1 wherein the first sensor package includes one or more gravity gradiometry sensors selected from the group of: an accelerometer, a gravimeter, an electromagnetic sensor, an electromechanical sensor, a magnetic sensor and a radiometric sensor.

9. The system of claim 1, wherein the first sensor package includes a plurality of gravity gradiometry sensors of the same type.

10. The system of claim 1, wherein the first sensor package includes a plurality of gravity gradiometry sensors having different sensitivities.

11. The system of claim 8, wherein the first sensor package further comprises one or more of: a RADAR, a LIDAR, a camera, and other measurement instruments.

12. The system of claim 1, wherein each sensor in the first sensor package is attached to the first autonomous vehicle by a tether configured to be lengthened or shortened to vary a distance between each sensor and the first autonomous vehicle.

13. (canceled)

14. (canceled)

15. The system of claim 1, wherein the data processing system comprises:
one or more algorithms configured for cross referencing the data received from the first sensor package with the data received from the second sensor package to validate data points in the survey model.

16. The system of claim 11, wherein the data processing system is on board the first autonomous vehicle and comprises
one or more algorithms configured for computer vision and autonomous control of the first autonomous vehicle.

17. (canceled)

18. The system of claim 1, where the data processing system is a cloud-based system in connection with the first autonomous vehicle and the at least second autonomous vehicle over a network.

19. (canceled)

20. A motion isolated autonomous vehicle platform for gravity gradiometry, comprising:
at least three autonomous vehicles attached to a sensor for gravity gradiometry measurements, wherein the sensor is suspended below, and substantially equidistant to, each of the autonomous vehicles,
wherein the three-dimensional movement of the autonomous vehicles are coordinated to change a position or an altitude of the sensor and minimize vibration felt by the sensor.

21. The motion isolated autonomous vehicle platform of claim 19, wherein each of the at least three autonomous vehicles is attached to the sensor by a tether, whereby each tether is lengthened or shortened by the same distance to raise or lower the sensor with respect to the autonomous vehicles and maintain equidistance between the sensor and each of the autonomous vehicles.

22. (canceled)

23. The motion isolated autonomous vehicle platform of claim 21, wherein each tether is lengthened to lower the sensor in a free fall for continuous measurement.

24. A method for gravity gradiometry, comprising:
providing one or more autonomous vehicles, each vehicle equipped with a customizable sensor package having one or more sensors for gravity gradiometry;
continuously recording a plurality of measurements by the sensors while the autonomous vehicles are stationary, hovering or moving across an area or a volume of space in a plurality of predetermined paths;
receiving the plurality of measurements from the sensors; and
processing the plurality of measurements, by a distributed network across the one or more autonomous vehicles, to obtain a plurality of measurements of the area or the volume of space.

25. (canceled)

26. (canceled)

27. The method of claim 24, further comprising:
turning the autonomous vehicles flight components on and off, wherein when the flight components are turned off, the autonomous vehicles enter a free fall and
continuously recording measurements by the sensors during the free fall.

28. (canceled)

29. The method of claim 27, wherein the predetermined path of a first autonomous vehicle and a second autonomous vehicle are the same in free fall.

30. The method of claim 27, wherein the predetermined path of a first autonomous vehicle and a second autonomous vehicle are different in free fall, while maintaining equidistance between the autonomous vehicles.
